(19) United States
(12) Patent Application Publication
(10) Pub. No.: US 2025/0106336 A1
(43) Pub. Date: Mar. 27, 2025

(54) IMAGE READING SYSTEM AND IMAGE FORMING SYSTEM

(71) Applicant: FUJIFILM Business Innovation Corp., Tokyo (JP)

(72) Inventors: Kazunori SATO, Kanagawa (JP); Norikazu SAKAI, Kanagawa (JP); Takashi ODA, Kanagawa (JP); Takaharu SATO, Kanagawa (JP); Yuki HANADA, Kanagawa (JP)

(73) Assignee: FUJIFILM Business Innovation Corp., Tokyo (JP)

(21) Appl. No.: 18/596,104

(22) Filed: Mar. 5, 2024

(30) Foreign Application Priority Data
Sep. 21, 2023 (JP) 2023-156533

(51) Int. Cl. H04N 1/00; G03G 15/00; H04N 1/12

(52) U.S. Cl. CPC H04N 1/00761; G03G 15/5062; H04N 1/125

(57) ABSTRACT

An image reading system includes a reading section that is provided in a conveyance path for conveying a document and that reads an image from the document conveyed through the conveyance path; a rotating member that is disposed opposite to the reading section across the conveyance path and rotates with a main scanning direction of the reading section as an axial direction; a flat white reference surface that is provided on an outer periphery of the rotating member and from which white reference data is read by the reading section; reference markers that are provided on both end sides of the white reference surface in the axial direction and are read by the reading section; and a processor that, in a case where rotation positions of the rotating member when the respective reference markers are read are different, sets a reading reference position of the white reference data between the read rotation positions of the rotating member and controls the reading section to perform reading at a position based on the reading reference position.

### CROSS-REFERENCE TO RELATED APPLICATIONS

This application is based on and claims priority under 35 USC 119 from Japanese Patent Application No. 2023-156533 filed Sep. 21, 2023.

### BACKGROUND

### (i) Technical Field

The present disclosure relates to an image reading system and an image forming system.

### (ii) Related Art

Japanese Unexamined Patent Application Publication No. 2004-112101 discloses an image reading apparatus including a line sensor having a plurality of photoelectric conversion elements arranged in a one dimensional manner, a white reference image reading unit that reads a white reference image of a white reference portion by the line sensor, a storage unit that stores white reference data based on an output from each of the photoelectric conversion elements, a shading correction unit that corrects, when an image of a document is read, the output from each of the photoelectric conversion elements based on the correction data, furthermore, a detection unit that detects a reading position mark indicating a starting position of the white reference portion, and a reference data reading unit that reads white reference data with reference to the position of the detected mark.

### SUMMARY

Aspects of non-limiting embodiments of the present disclosure relate to suppressing a variation in a quality of an image after correction using white reference data, as compared with a configuration in which a reference marker is provided on only one end side of a white reference surface in an axial direction of a rotating member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image reading system including: a reading section that is provided in a conveyance path for conveying a document and that reads an image from the document conveyed through the conveyance path; a rotating member that is disposed opposite to the reading section across the conveyance path and rotates with a main scanning direction of the reading section as an axial direction; a flat white reference surface that is provided on an outer periphery of the rotating member and from which white reference data is read by the reading section; reference markers that are provided on both end sides of the white reference surface in the axial direction and are read by the reading section; and a processor that, in a case where rotation positions of the rotating member when the respective reference markers are read are different, sets a reading reference position of the white reference data between the read rotation positions of the rotating member and controls the reading section to perform reading at a position based on the reading reference position.

### BRIEF DESCRIPTION OF THE DRAWINGS

Exemplary embodiments of the present disclosure will be described in detail based on the following figures, wherein:

FIG. 1 is a schematic diagram illustrating an image forming apparatus according to the present exemplary embodiment;

FIG. 2 is a perspective diagram illustrating the image forming apparatus according to the present exemplary embodiment;

FIG. 3 is a perspective diagram illustrating a state in which a document table is moved to an open position in the configuration illustrated in FIG. 2;

FIG. 4 is a sectional diagram illustrating an upper portion (image reading section) of the image forming apparatus according to the present exemplary embodiment;

FIG. 5 is a sectional diagram illustrating a state in which the document table is moved to the open position in the configuration illustrated in FIG. 4;

FIG. 6 is a plan diagram illustrating a state in which the document table of the image forming apparatus according to the present exemplary embodiment is moved to the open position;

FIG. 7 is a block diagram illustrating a hardware configuration of the image forming apparatus according to the present exemplary embodiment;

FIG. 8 is an enlarged diagram of a configuration of a main part of the image reading section illustrated in FIG. 1, illustrating a state in which reading of a recording medium is executed;

FIG. 9 is an enlarged diagram of a configuration of a main part of the image reading section illustrated in FIG. 1, illustrating a state in which reading of a white reference surface is being executed;

FIG. 10 is a schematic side diagram of a reading sensor and an opposing roll for describing a relationship between the reading sensor and the opposing roll of the image reading section illustrated in FIG. 1;

FIG. 11 is a plan diagram of the opposing roll when the white reference surface is viewed from an optical axis direction of the reading sensor;

FIG. 12 is a plan diagram of the opposing roll for describing a method for determining a reading reference position of the white reference surface in a state where a skew occurs in the opposing roll illustrated in FIG. 11;

FIG. 13 is a schematic side diagram of the reading sensor and the opposing roll for describing a relationship between the opposing roll and the reading sensor in a case where a skew occurs;

FIG. 14 is a schematic side diagram of the reading sensor and the opposing roll for describing a relationship between the opposing roll and the reading sensor in a case where a skew occurs;

FIG. 15 is a flowchart for describing an initial operation for acquiring white reference data;

FIG. 16 is a flowchart for describing second and subsequent operations for acquiring the white reference data;

FIG. 17 is an enlarged plan diagram illustrating an end portion of a white reference surface of a modification example;

FIG. 18 is an enlarged plan diagram illustrating an end portion of a white reference surface of another modification example;

FIG. 19 is a plan diagram of the opposing roll when the white reference surface of the modification example is viewed from the optical axis direction of the reading sensor;

FIG. 20 is a plan diagram of the opposing roll for describing a method for determining the reading reference position of the white reference surface in a state in which a skew occurs in the opposing roll illustrated in FIG. 19;

FIG. 21 is a schematic side diagram of the reading sensor and the opposing roll illustrating an inclination of the white reference surface when a first skew detection marker is detected;

FIG. 22 is a schematic side diagram of the reading sensor and the opposing roll illustrating an inclination of the white reference surface when a second skew detection marker is detected; and

FIG. 23 is a block diagram illustrating a hardware configuration of an image reading apparatus according to other exemplary embodiments.

### DETAILED DESCRIPTION

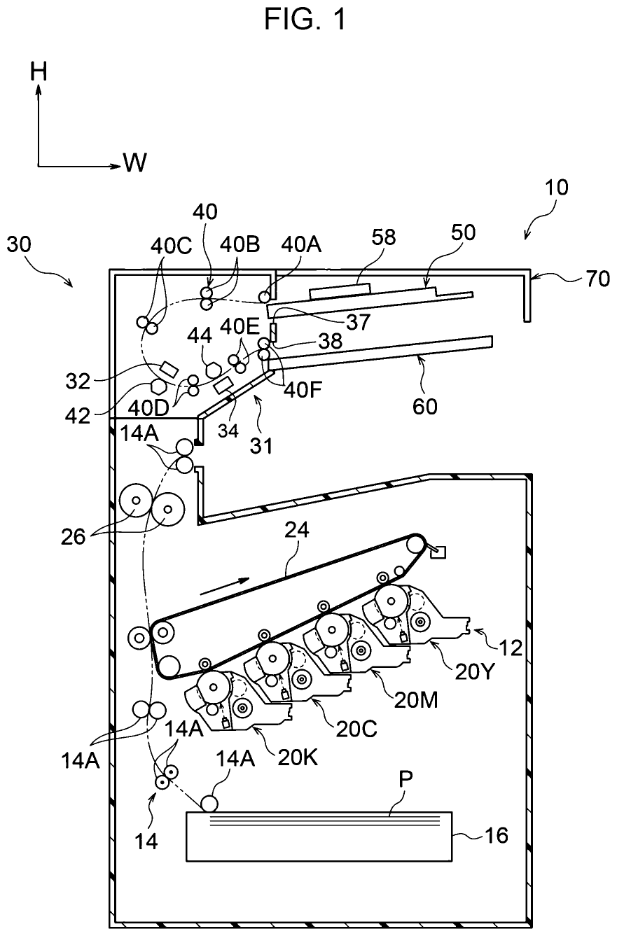

Examples of an image reading system and an image forming system according to an exemplary embodiment of the present disclosure will be described with reference to FIGS. 1 to 16. An image forming apparatus 10 illustrated in FIG. 1 is an example of an image forming system that forms an image on a recording medium P.

An arrow H indicated in each drawing indicates an apparatus up-down direction (specifically, a vertical direction) of the image forming apparatus 10. An arrow W indicates an apparatus width direction (specifically, a horizontal direction) of the image forming apparatus 10. An arrow D indicates an apparatus depth direction (specifically, a horizontal direction) of the image forming apparatus 10. The apparatus up-down direction, the apparatus width direction, and the apparatus depth direction of the image forming apparatus 10 intersect (specifically, are orthogonal to) each other.

One of the one side and the other side in the apparatus width direction corresponds to a left side of the image forming apparatus 10. Therefore, hereinafter, one side in the apparatus width direction is referred to as a left side. The other side in the apparatus width direction corresponds to a right side of the image forming apparatus 10. Therefore, hereinafter, the other side in the apparatus width direction is referred to as a right side. Since these directions are defined for convenience of explanation, the apparatus configuration is not limited to these directions.

One of the one side and the other side in the apparatus depth direction corresponds to a front side of the image forming apparatus 10. Therefore, hereinafter, one side in the apparatus depth direction is referred to as a front side. The other side in the apparatus depth direction corresponds to a rear side of the image forming apparatus 10. Therefore, hereinafter, the other side in the apparatus depth direction is referred to as a rear side. Since these directions are defined for convenience of description, the apparatus configuration is not limited to these directions.

As illustrated in FIG. 1, the image forming apparatus 10 includes a conveying section 14, an image forming section 12, an image reading section 30, a conveyance mechanism 40, a document table 50, a discharge portion 60, and a document table 70. Note that the image reading section 30 in the present exemplary embodiment is an example of the image reading system.

As illustrated in FIG. 1, the conveying section 14 conveys a recording medium P such as a sheet stored in an accommodating section 16. Specifically, the conveying section 14 has conveyance members 14A such as a plurality of conveyance rolls and conveys the recording medium P by the conveyance members 14A.

### [Image Forming Section 12]

As illustrated in FIG. 1, the image forming section 12 is a section having a function of forming an image on the recording medium P conveyed by the conveying section 14 in the image forming apparatus 10. The image forming section 12 forms an image on the recording medium P based on image information read by the image reading section 30.

Specifically, the image forming section 12 forms a toner image (an example of the image) on the recording medium P by an electrophotographic method. More specifically, the image forming section 12 has toner image forming sections 20Y, 20M, 20C, and 20K (hereinafter, referred to as 20Y to 20K), a transfer body 24, and a fixing section 26.

In the image forming section 12, the toner image forming sections 20Y to 20K perform charging, exposing, developing, and transferring processes, respectively, and a toner image of each color of yellow (Y), magenta (M), cyan (C), and black (K) is formed on the transfer body 24. Further, in the image forming section 12, the toner image of each color formed on the transfer body 24 is transferred to the recording medium P, and the toner image is fixed to the recording medium P by the fixing section 26. As described above, an intermediate transfer method is used in which the image is transferred to the recording medium P via the transfer body 24 in the image forming section 12.

### [Image Reading Section 30]

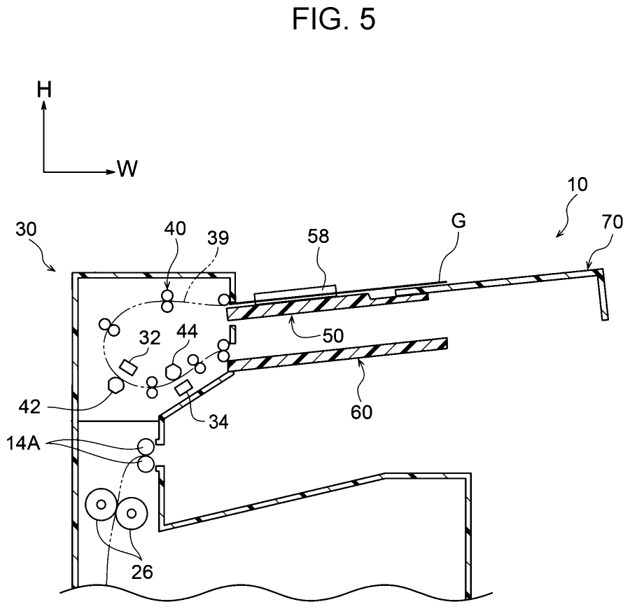

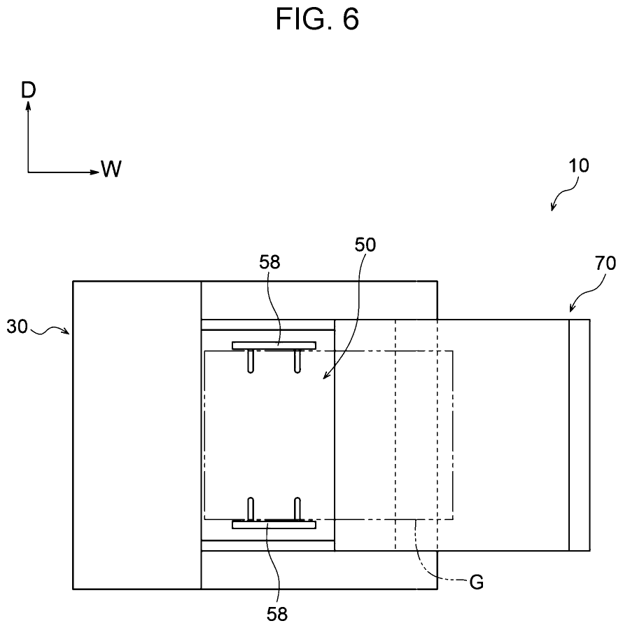

As illustrated in FIGS. 5 and 6, the image reading section 30 is a section having a function of reading an image of a document G conveyed, in the image forming apparatus 10. As illustrated in FIG. 1, the image reading section 30 is installed on an upper side with respect to the image forming section 12. In other words, the image reading section 30 constitutes an upper portion of the image forming apparatus 10. The image reading section 30 has a housing 31, a reading sensor 32, a reading sensor 34, an opposing roll 42, an opposing roll 44, a white reference surface 46, and reference markers 80. The reading sensor 32 and the reading sensor 34 of the present exemplary embodiment are an example of a reading section of the present disclosure. Furthermore, the opposing roll 42 and the opposing roll 44 of the present exemplary embodiment are an example of a rotating member of the present disclosure. Further, a curved surface 43B of the present exemplary embodiment is an example of a support surface of the present disclosure.

### (Housing 31)

As illustrated in FIGS. 1, 4, and 5, the housing 31 accommodates therein the reading sensor 32, the reading sensor 34, a conveyance path 39, and the conveyance mechanism 40.

The conveyance path 39 is a path for conveying the document G placed on the document table 50 from a receiving port 37 to a discharge port 38 (that is, the discharge portion 60). Specifically, in FIG. 1, the conveyance path 39 extends from the receiving port 37 toward the back, curves in an arc shape in the middle, and extends toward the discharge port 38. In the present exemplary embodiment, as an example, the conveyance path 39 extends in a C-shape from the receiving port 37 to the discharge port 38 (see FIG. 1).

The conveyance mechanism 40 is a mechanism that conveys the document G along the conveyance path 39. Specifically, the conveyance mechanism 40 has a plurality of conveyance members such as conveyance rolls. Specifically, the conveyance mechanism 40 has conveyance members 40A, 40B, 40C, 40D, 40E, and 40F. The conveyance members 40A, 40B, 40C, 40D, 40E, and 40F are disposed in order from an upstream of the conveyance path 39.

### (Reading Sensor 32)

The reading sensor 32 is a component having a reading function of reading an image on one surface of the conveyed document G (for example, a back surface of the document G). The one surface of the document G of the present exemplary embodiment is an example of a first surface of the document G in the present disclosure. As the reading sensor 32, for example, a contact-type image sensor called a contact image sensor (CIS) is used.

As illustrated in FIGS. 1, 8, and 9, the reading sensor 32 is provided on the conveyance path 39. In the present exemplary embodiment, as an example, the reading sensor 32 is disposed between a pair of conveyance members 40C and a pair of conveyance members 40D.

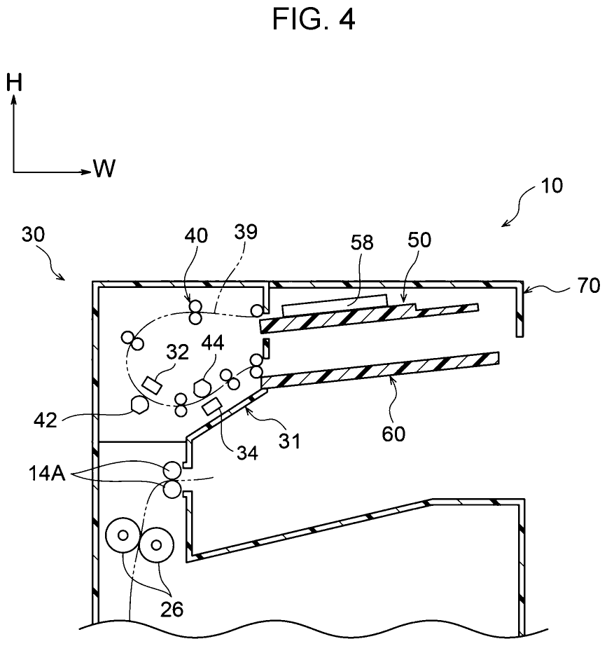

In the present exemplary embodiment, as an example, the reading sensor 32 is directed diagonally downward left as illustrated in FIGS. 4 and 5.

### (Reading Sensor 34)

The reading sensor 34 is a component having a reading function of reading an image on the other surface of the conveyed document G (a surface opposite to the one surface of the document G, for example, a front surface of the document G). The other surface of the document G of the present exemplary embodiment is an example of a second surface of the document G in the present disclosure. As the reading sensor 34, for example, a contact-type image sensor called a contact image sensor (CIS) is used.

As illustrated in FIGS. 1, 8, and 9, the reading sensor 34 is provided on the conveyance path 39. Specifically, the reading sensor 34 is disposed downstream of the reading sensor 32 in the conveyance path 39. In the present exemplary embodiment, as an example, the reading sensor 34 is disposed between a pair of conveyance members 40D and a pair of conveyance members 40E.

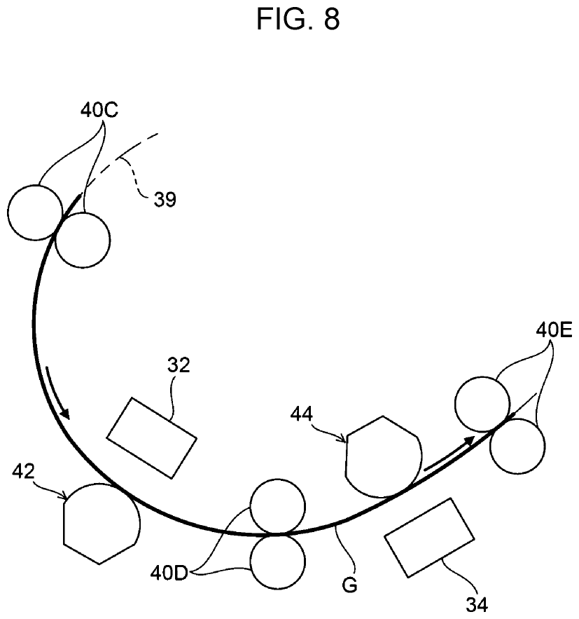

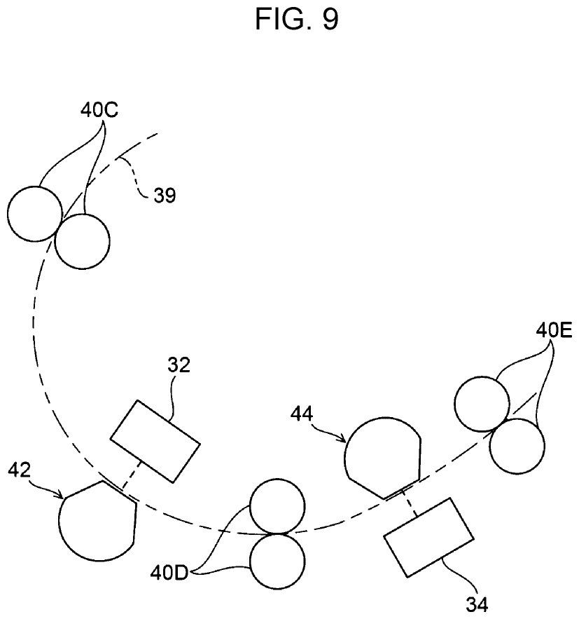

In the present exemplary embodiment, as an example, the reading sensor 34 is directed diagonally upward left as illustrated in FIGS. 8 and 9.

### (Opposing Roll 42)

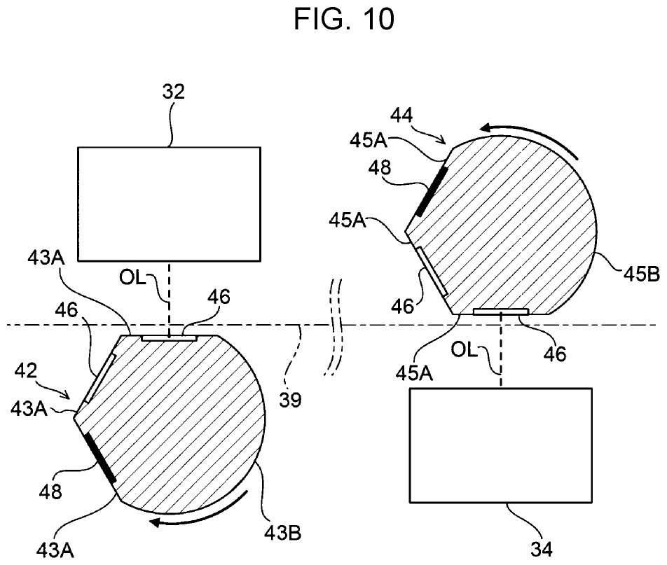

As illustrated in FIGS. 8 and 10, the opposing roll 42 is disposed opposite to the reading sensor 32 across the conveyance path 39. The opposing roll 42 is a roll-shaped component and is supported so as to be rotatable with a main scanning direction MS of the reading sensor 32 as an axial direction. Furthermore, the opposing roll 42 is rotatably supported by a bearing (not illustrated) provided in the housing 31. Note that the main scanning direction MS of the reading sensor 32 is the same direction as the apparatus depth direction in the present exemplary embodiment.

As illustrated in FIG. 10, the opposing roll 42 has three flat surfaces 43A and a curved surface 43B curved in an arc shape. The three flat surfaces 43A and the curved surface 43B configure an outer periphery of the opposing roll 42.

Furthermore, as illustrated in FIG. 8, the curved surface 43B is configured to be able to support the document G conveyed through the conveyance path 39. Specifically, the curved surface 43B supports the other surface of the document G.

The opposing roll 42 is configured to be rotatable by a drive source (not illustrated). The drive source is controlled by a processor 100 to be described later. Specifically, a rotation direction, a rotation angle, a rotation speed, and the like of the opposing roll 42 are controlled by the processor 100.

### (White Reference Surface 46)

As illustrated in FIG. 10, flat white reference surfaces 46 are provided on the outer periphery of the opposing roll 42. The white reference surface 46 extends in the axial direction of the opposing roll 42. Specifically, a long white reference member is embedded in the flat surface 43A of the opposing roll 42 to form the white reference surface 46. In the present exemplary embodiment, the white reference surface 46 and the flat surface 43A are flush with each other, but the present disclosure is not limited to this configuration, and there may be a step between the white reference surface 46 and the flat surface 43A. The white reference surface 46 is, for example, a color reference surface for shading correction, and data serving as a white reference is read by the reading sensor 32.

### (Reference Marker 80)

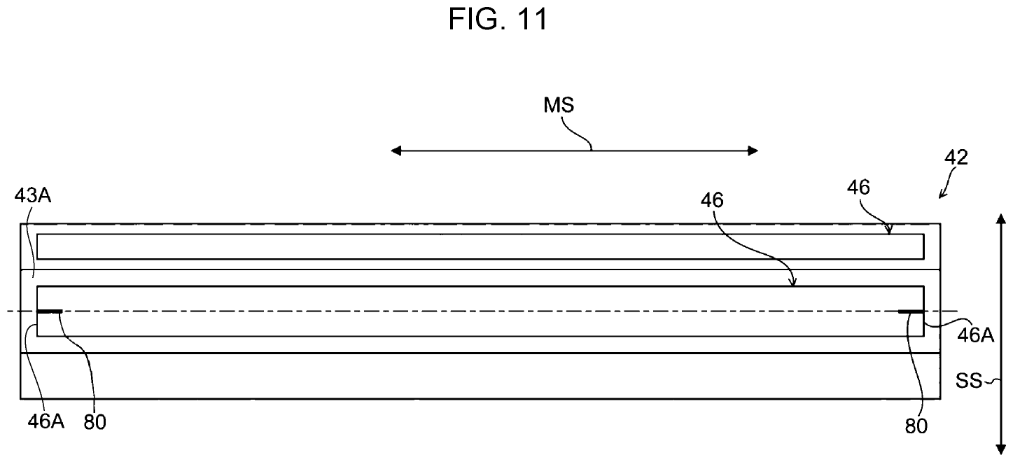

As illustrated in FIG. 11, reference markers 80 are provided on both ends 46A of the white reference surface 46 in the axial direction of the opposing roll 42 (in other words, both end sides of the white reference surface in a longitudinal direction). Each of the reference markers 80 is a marker to be read by the reading sensor 32, respectively. Note that the reading of the reference markers 80 by the reading sensor 32 as used herein refers to detection of the reference markers 80 from the rotating opposing roll 42 by the reading sensor 32.

Each of the reference markers 80 is provided at a center of the white reference surface 46 in the width direction orthogonal to the longitudinal direction. Each of the reference markers 80 is a linear marker extending along the longitudinal direction of the white reference surface 46. Note that although each of the reference markers 80 is a continuous linear marker (solid line marker) in the present exemplary embodiment, the present disclosure is not limited to this configuration. For example, a marker of a line type such as a broken line, a one-dot chain line, or a two-dot chain line may be used.

In the present exemplary embodiment, the white reference surface 46 is provided on each of the two flat surfaces 43A, but the present disclosure is not limited to this configuration, and the white reference surface 46 may be provided on one flat surface 43A.

Furthermore, in the present exemplary embodiment, a black reference surface 48 is provided on the flat surface 43A on which the white reference surface 46 is not provided. The black reference surface 48 extends in the axial direction of the opposing roll 42. Specifically, a long black reference member is embedded in the flat surface 43A of the opposing roll 42 to form the black reference surface 48. In the present exemplary embodiment, the black reference surface 48 and the flat surface 43A are flush with each other, but the present disclosure is not limited to this configuration, and there may be a step between the black reference surface 48 and the flat surface 43A. The black reference surface 48 is a color reference surface, and data serving as a black reference is read by the reading sensor 32.

### (Opposing Roll 44)

As illustrated in FIGS. 8 and 10, the opposing roll 44 is disposed opposite to the reading sensor 34 across the conveyance path 39. The opposing roll 44 is a roll-shaped component and is supported so as to be rotatable with the main scanning direction MS of the reading sensor 34 as an axial direction. Furthermore, the opposing roll 44 is rotatably supported by a bearing (not illustrated) provided in the housing 31. Note that the main scanning direction of the reading sensor 34 is the same direction as the apparatus depth direction in the present exemplary embodiment.

As illustrated in FIG. 10, the opposing roll 44 has three flat surfaces 45A and a curved surface 45B curved in an arc shape. The three flat surfaces 45A and the curved surface 45B configure an outer periphery of the opposing roll 44.

Furthermore, as illustrated in FIG. 8, the curved surface 45B is configured to be able to support the document G conveyed through the conveyance path 39. Specifically, the curved surface 45B supports the one surface of the document G.

The opposing roll 44 is configured to be rotatable by a drive source (not illustrated). The drive source is controlled by the processor 100 to be described later. Specifically, a rotation direction, a rotation angle, a rotation speed, and the like of the opposing roll 44 are controlled by the processor 100.

As illustrated in FIG. 10, a flat white reference surface 46 is provided on the outer periphery of the opposing roll 44, similarly to the opposing roll 42. The white reference surface 46 extends in the axial direction of the opposing roll 44. Specifically, a white reference member is embedded in the flat surface 45A of the opposing roll 44 to form the white reference surface 46. In the present exemplary embodiment, the white reference surface 46 and the flat surface 45A are flush with each other, but the present disclosure is not limited to this configuration, and there may be a step between the white reference surface 46 and the flat surface 45A. The white reference surface 46 provided on the outer periphery of the opposing roll 44 is also provided with the reference markers 80 in the same manner as described above. Each of the reference markers 80 is a marker to be read (detected) by the reading sensor 34, respectively. Furthermore, in the present exemplary embodiment, the white reference surface 46 is provided on each of the two flat surfaces 45A, but the present disclosure is not limited to this configuration, and the white reference surface 46 may be provided on one flat surface 45A. Furthermore, in the present exemplary embodiment, a black reference surface 48 is provided on the flat surface 45A on which the white reference surface 46 is not provided. The black reference surface 48 extends in the axial direction of the opposing roll 44. Specifically, a long black reference member is embedded in the flat surface 45A of the opposing roll 44 to form the black reference surface 48. In the present exemplary embodiment, the black reference surface 48 and the flat surface 45A are flush with each other, but the present disclosure is not limited to this configuration, and there may be a step between the black reference surface 48 and the flat surface 45A.

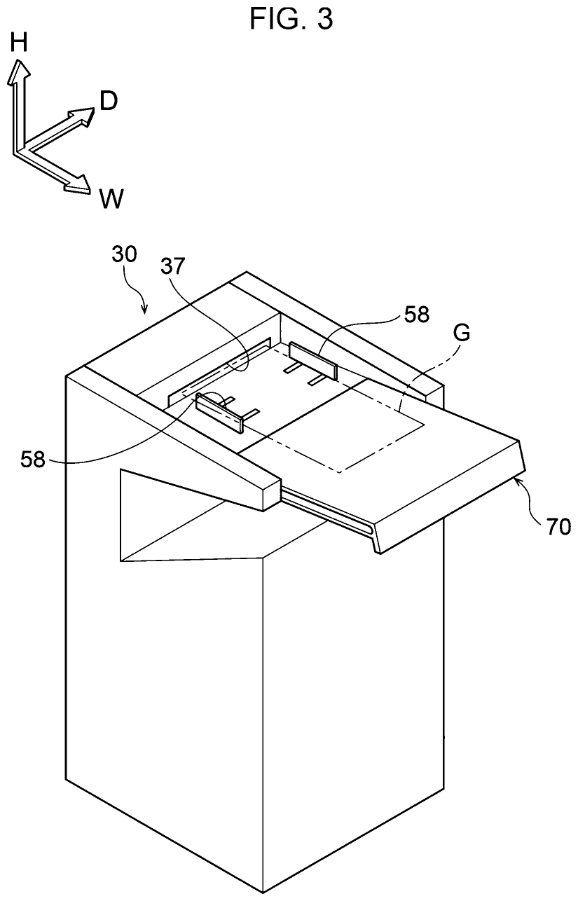

As illustrated in FIGS. 3 and 5, the document table 50 is a table on which the document G whose image is read by the image reading section 30 (see FIG. 1) is placed. That is, the document table 50 is a portion on which the document G conveyed by the conveyance mechanism 40 (see FIG. 1) is placed.

In the present exemplary embodiment, as will be described later, in a state where the document table 70 is located at an open position, the document G is placed on the document table 50 from above.

In the present exemplary embodiment, the term “document table” is used to mean a table on which the document G is placed. Therefore, the term “table” does not include a meaning of specifying a shape.

As illustrated in FIG. 1, the document table 50 is installed on the right side with respect to the image reading section 30. The document table 50 is installed on a lower side with respect to the document table 70.

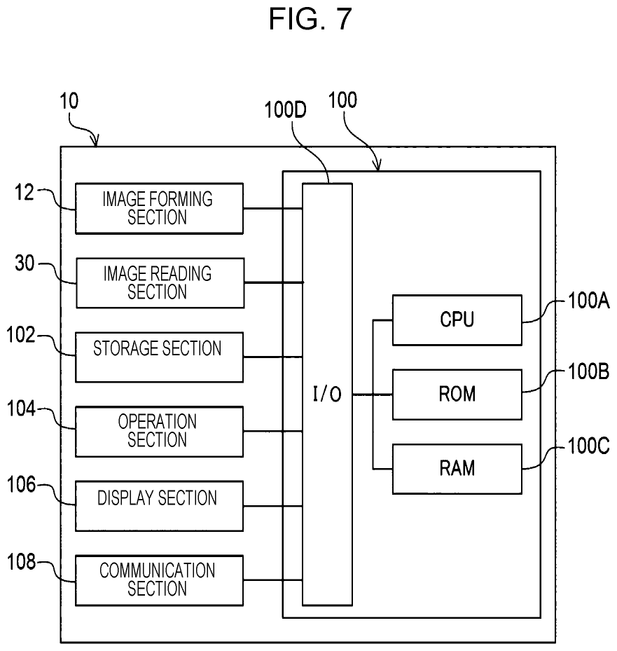

As illustrated in FIGS. 3 and 7, the document table 50 is provided with restriction sections 58 (so-called side guide). The restriction sections 58 come into contact with side edges of the document G placed on the document table 50 and restrict movement of the document G to one side and the other side in the apparatus depth direction.

The discharge portion 60 illustrated in FIG. 5 is a portion to which the document G whose image has been read by the image reading section 30 is discharged. That is, it can be said that the discharge portion 60 is a portion on which the document G conveyed by the conveyance mechanism 40 is placed.

The discharge portion 60 is installed on a lower side of the document table 50.

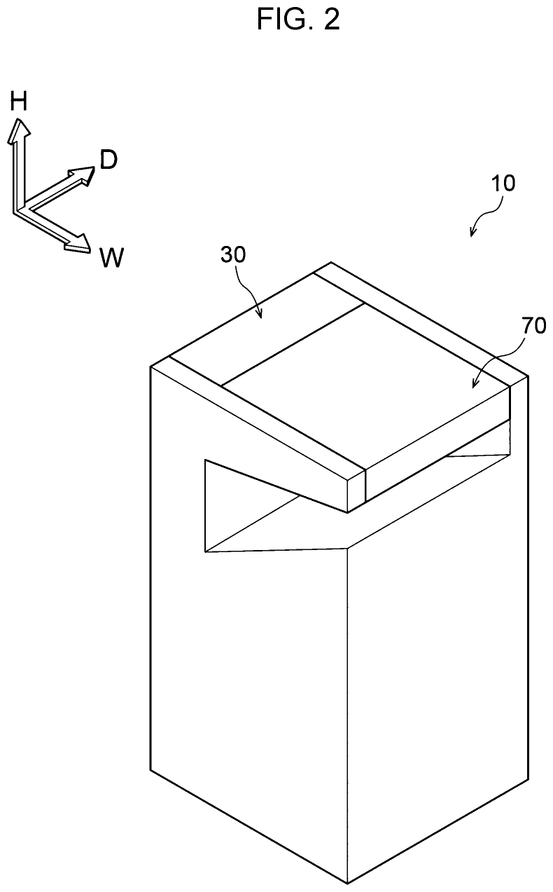

As illustrated in FIGS. 2 and 4, the document table 70 is a table on which the document G is placed. The document table 70 is installed on the upper side of the document table 50.

The document table 70 is movable between a covered position (a position illustrated in FIGS. 1, 2, and 4) at which the document table 50 is covered from above and the open position (a position illustrated in FIGS. 3 and 5) at which the upper side of the document table 50 is opened. In the present exemplary embodiment, the document table 70 is supported by the housing 31 so as to be movable to the covered position and the open position.

As illustrated in FIGS. 3 and 5, a part of the document G placed on the document table 50 is placed on the document table 70 in the open position.

Next, a hardware configuration of the image forming apparatus 10 according to the present exemplary embodiment will be described with reference to FIG. 7. Note that FIG. 7 does not illustrate the entire hardware configuration of the image forming apparatus 10 but illustrates the main configuration of the image forming apparatus 10.

As illustrated in FIG. 7, the image forming apparatus 10 has a processor 100, a storage section 102, an operation section 104, a display section 106, a communication section 108, the image forming section 12, the image reading section 30, and the like.

### (Processor 100)

The processor 100 includes a central processing unit (CPU) 100A, a read only memory (ROM) 100B, a random access memory (RAM) 100C, and an input/output interface (I/O) 100D. The processor 100 controls the overall operation of the image forming apparatus 10. For example, various types of control programs, various types of parameters, and the like are stored in the ROM 100B in advance. The RAM 100C is used as a work area or the like when various types of programs are executed by the CPU 100A. The storage section 102 stores various types of programs and various types of data for executing print processing, application programs, or the like. The operation section 104 is used to input various types of information. The display section 106 is used for displaying various types of information. The communication section 108 is an interface for transmitting and receiving various types of data to and from an external apparatus such as a server, for example. The communication section 108 may be configured to be able to directly communicate with each device by using short-range wireless communication such as Wi-Fi (registered trademark) or Bluetooth (registered trademark). Respective sections of the image forming apparatus 10 are electrically coupled to each other by a system bus.

Next, operations of the processor 100 according to the present exemplary embodiment will be described, but since the operations of the processor 100 include an operation corresponding to a skew of the opposing roll, first, the skew of the opposing roll and a case where the skew occurs will be described.

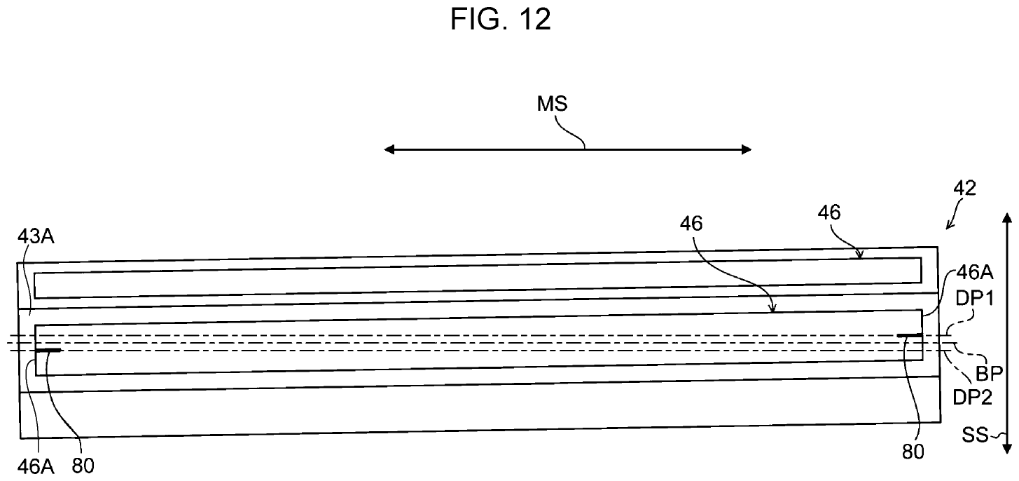

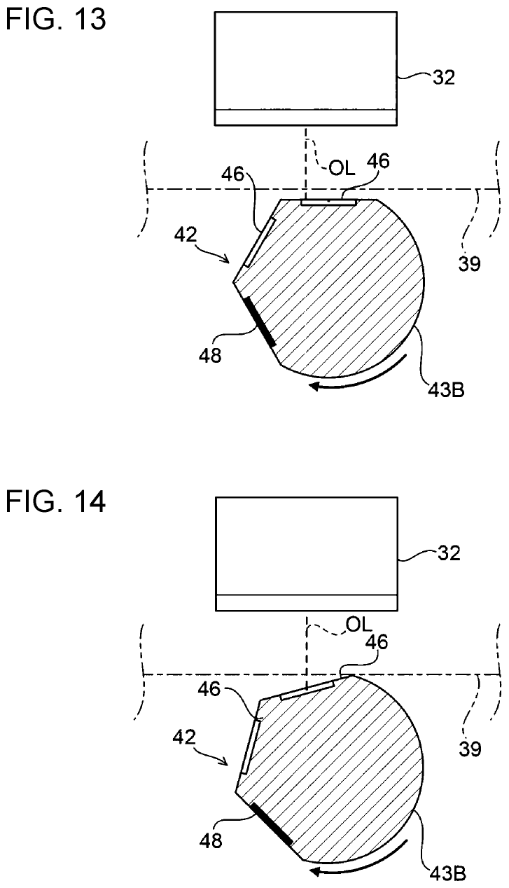

When the image reading section 30 is manufactured (assembled), the image reading section 30 may be attached in a state in which the axial direction of the opposing roll is slightly inclined with respect to the main scanning direction of the reading sensor when viewed from an optical axis direction of the reading sensor. When viewed from the optical axis direction of the reading sensor, a state in which the axial direction of the opposing roll is inclined with respect to the main scanning direction of the reading sensor is a skew. The skew indicates a relative inclination between the main scanning direction of the reading sensor and the axial direction of the opposing roll. FIG. 12 illustrates a state in which the opposing roll 42 is inclined with respect to the main scanning direction MS of the reading sensor 32. For example, in a case where a skew occurs in the opposing roll 42, as illustrated in FIG. 10, the reference marker 80 may be located on an optical axis OL in an orthogonal state where the white reference surface 46 is orthogonal to the optical axis OL of the reading sensor 32 at one end portion of the opposing roll 42, and as illustrated in FIG. 13, the reference marker 80 may be located at a position deviated from the optical axis OL in the orthogonal state where the white reference surface 46 is orthogonal to the optical axis OL at the other end portion of the opposing roll 42. Therefore, in a case where a skew occurs in the opposing roll 42, the reference marker 80 is detected by the reading sensor 32 at the one end portion of the opposing roll 42 when the white reference surface 46 is in the orthogonal state, and the reference marker 80 is detected by the reading sensor 32 at the other end portion of the opposing roll 42 when the white reference surface 46 is not in the orthogonal state, specifically, when it is in an inclined state in which the white reference surface 46 is inclined with respect to the optical axis direction of the reading sensor 32. Here, in a case where the reference marker 80 detected when the white reference surface 46 is in the inclined state illustrated in FIG. 14 is set as a reading position of the white reference data, incident light from the reading sensor 32 on the white reference surface 46 is obliquely incident on the white reference surface 46. In this way, in a case where the incident light from the reading sensor 32 is obliquely incident on the white reference surface 46, an amount of reflected light is reduced, for example, compared to a case where the incident light is vertically incident on the white reference surface 46. Therefore, a mismatch occurs between the white reference data for shading correction acquired by the reading sensor 32 and the image information of the document G read by the reading sensor 32, and it is conceivable that a part of the image after the shading correction becomes bright or a part of the image becomes blurred.

In consideration of the above, in a case where the rotation positions of the opposing roll 42 when the respective reference markers 80 are read (detected) are different, the processor 100 according to the present exemplary embodiment sets a reading reference position of the white reference data between the detected rotation positions of the opposing roll 42, and performs control such that the reading sensor 32 performs reading at a position based on the reading reference position. Note that in FIG. 12, the positions at which the reading sensor 32 detects the reference markers 80 on the white reference surface 46 are indicated by one-dot chain lines of reference signs DP1 and DP2. In FIG. 12, the reading reference position is set between the detection positions DP1 and DP2. The reading reference position is indicated by a one-dot chain line of a reference sign BP. The one-dot chain lines illustrated in FIG. 12 are parallel to the main scanning direction MS of the reading sensor 32. Further, the position based on the reading reference position includes the reading reference position. That is, the processor 100 may control the reading sensor 32 to perform reading at the reading reference position set between the detected rotation positions of the opposing roll 42.

The processor 100 also sets, as a reading reference position, a central position between the rotation positions of the opposing roll 42 at which the respective reference markers 80 are detected. Specifically, the processor 100 sets, as the reading reference position, a central position in a sub-scanning direction SS of the reading sensor 32 between the rotation positions of the opposing roll 42 at which the respective reference markers 80 are detected.

Furthermore, as illustrated in FIG. 8, the processor 100 may control the rotation position of the opposing roll 42 so that the curved surface 43B of the opposing roll 42 faces the conveyance path 39 when the document G passes between the opposing roll 42 and the reading sensor 32.

The processor 100 also performs the same control for the opposing roll 44 as that for the opposing roll 42. Therefore, description of the control of the opposing roll 44 by the processor 100 will be omitted.

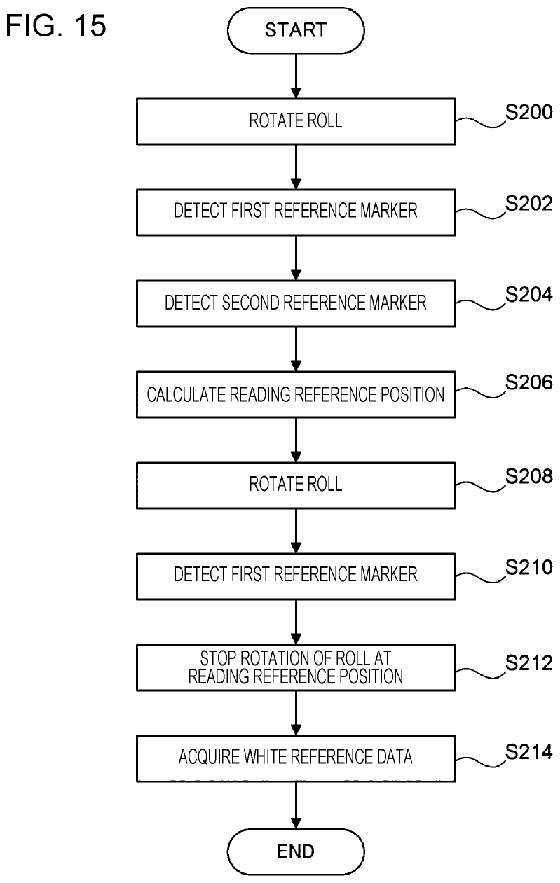

Next, a flow of processing of the processor 100 until the white reference data is acquired from the white reference surface 46 in a case where a skew occurs in the opposing roll in the present exemplary embodiment will be described with reference to FIG. 15. Note that both the opposing roll 42 and the opposing roll 44 are controlled in the same manner by the processor 100, and therefore, the opposing roll 42 will be described below as a representative.

For example, in a case where it is necessary to acquire white reference data for shading correction at the time of starting the apparatus or the like, first, in step S200, the opposing roll 42 is rotated.

Next, in step S202, a first reference marker 80 from the white reference surface 46 of the rotating opposing roll 42 is detected using the reading sensor 32. Then, a rotation position of the opposing roll 42 when the first reference marker 80 is detected by the reading sensor 32 is stored in the RAM 100C or the storage section 102.

Next, in step S204, a second reference marker 80 from the white reference surface 46 of the rotating opposing roll 42 is detected using the reading sensor 32. Then, a rotation position of the opposing roll 42 when the second reference marker 80 is detected by the reading sensor 32 is stored in the RAM 100C or the storage section 102.

Next, in step S206, a reading reference position of the white reference surface 46 is calculated. Specifically, the rotation position of the opposing roll 42 when the first reference marker 80 is detected and the rotation position of the opposing roll 42 when the second reference marker 80 is detected are read from the RAM 100C or the storage section 102, and a position between the two rotation positions is calculated as the reading reference position. The calculated reading reference position is stored in the RAM 100C or the storage section 102.

Next, in step S208, the opposing roll 42 is rotated.

Next, in step S210, the first reference marker 80 from the white reference surface 46 of the rotating opposing roll 42 is detected using the reading sensor 32. Then, a rotation position of the opposing roll 42 when the first reference marker 80 is detected by the reading sensor 32 is stored in the RAM 100C or the storage section 102.

Next, in step S212, the rotation of the opposing roll 42 is stopped at the reading reference position. Specifically, an amount of rotation of the opposing roll 42 is controlled such that the rotation of the opposing roll 42 stops at the reading reference position from the rotation position of the first reference marker 80 detected in step S210. For example, after the calculation of the reading reference position of the opposing roll 42, the amount of rotation from the position of the rotation of the first reference marker 80 to the reading reference position of the opposing roll 42 is obtained. Next, in step S210, the opposing roll 42 is rotated by the obtained amount of rotation from the rotation position where the first reference marker 80 is detected. Thus, the rotation of the opposing roll 42 can be stopped at the reading reference position.

Next, in step S212, the reading sensor 32 is caused to acquire white reference data at the reading reference position from the white reference surface 46.

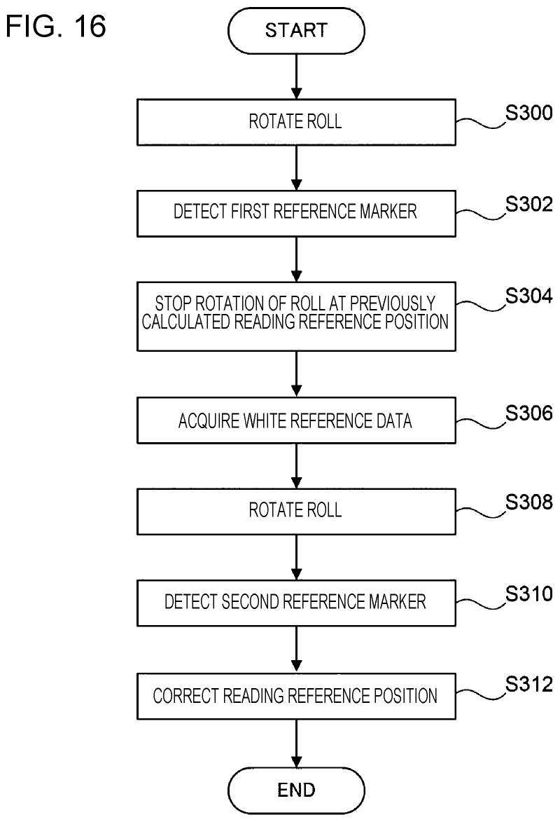

Next, in the present exemplary embodiment, a flow of processing of the processor 100 until the white reference data is acquired from the white reference surface 46 for the second and subsequent times in a case where a skew occurs in the opposing roll will be described with reference to FIG. 16. Note that in the same manner as described above, the opposing roll 42 will be described as a representative.

In a case where it is necessary to further acquire white reference data for shading correction after the acquisition of the initial white reference data, first, in step S300, the opposing roll 42 is rotated.

Next, in step S302, the first reference marker 80 from the white reference surface 46 of the rotating opposing roll 42 is detected using the reading sensor 32. Then, a rotation position of the opposing roll 42 when the first reference marker 80 is detected by the reading sensor 32 is stored in the RAM 100C or the storage section 102.

Next, in step S304, the rotation of the opposing roll 42 is stopped at the previously calculated reading reference position. Specifically, an amount of rotation of the opposing roll 42 is controlled such that the rotation of the opposing roll 42 stops at the reading reference position from the rotation position of the first reference marker 80 detected in step S302. For example, after the calculation of the reading reference position of the opposing roll 42, the amount of rotation from the position of the rotation of the first reference marker 80 to the reading reference position of the opposing roll 42 is obtained. Next, in step S302, the opposing roll 42 is rotated by the obtained amount of rotation from the rotation position where the first reference marker 80 is detected. Thus, the rotation of the opposing roll 42 can be stopped at the reading reference position.

Next, in step S306, the reading sensor 32 is caused to acquire white reference data at the reading reference position from the white reference surface 46.

Next, in step S308, the opposing roll 42 is rotated.

Next, in step S310, a second reference marker 80 from the white reference surface 46 of the rotating opposing roll 42 is detected using the reading sensor 32. Then, a rotation position of the opposing roll 42 when the second reference marker 80 is detected by the reading sensor 32 is stored in the RAM 100C or the storage section 102.

Next, in step S312, a reading reference position of the white reference surface 46 is corrected. Specifically, the rotation position of the opposing roll 42 when the first reference marker 80 is detected in step S302 and the rotation position of the opposing roll 42 when the second reference marker 80 is detected in step S310 are read from the RAM 100C or the storage section 102, and a position between the two rotation positions is calculated as the reading reference position. The calculated reading reference position is stored in the RAM 100C or the storage section 102 as a new reading reference position of the white reference surface 46. That is, the previous reading reference position of the white reference surface 46 is overwritten as the new reading reference position.

Next, operational effects of the present exemplary embodiment will be described. Note that although the following description will be given using the opposing roll 42 as a representative of the opposing roll and the reading sensor 32 as a representative of the reading sensor, similar operational effects can be obtained with the opposing roll 44 and the reading sensor 34.

In the present exemplary embodiment, in a case where the rotation positions of the opposing roll 42 when the respective reference markers 80 are read (detected) are different, the processor 100 sets a reading reference position of the white reference data between the read rotation positions of the opposing roll 42 and performs control such that the white reference data is read by the reading sensor 32 at a position based on the reading reference position. Here, in a case where the reading reference position of the white reference data is set between the read rotation positions of the opposing roll 42, the white reference surface 46 approaches an orthogonal state with respect to the optical axis OL of the reading sensor 32 at the reading reference position. Therefore, in the present exemplary embodiment, for example, compared to a configuration in which the reference marker 80 is provided only on one end side of the white reference surface 46 in the longitudinal direction, it is possible to suppress a variation in the amount of reflected light from the reading sensor 32 regardless of the rotation direction of the opposing roll 42. Therefore, it is possible to suppress a variation in the quality of an image after correction (after shading correction) using the white reference data.

In the present exemplary embodiment, the processor 100 sets a central position between the rotation positions of the opposing roll 42 at which the reference markers 80 are read as the reading reference position. Here, since the processor 100 sets the central position as the reading reference position, for example, compared to a configuration in which a position separated from the central position is set as the reading reference position, it is possible to suppress a variation in the amount of reflected light from the reading sensor 32 regardless of the rotation direction of the opposing roll 42 and to suppress a variation in the quality of an image after shading correction.

Furthermore, in the present exemplary embodiment, the reference marker 80 is provided at a center of the white reference surface 46 in the width direction. Therefore, in the present exemplary embodiment, compared to a configuration in which the reference marker 80 is provided at a position separated from the center of the white reference surface 46 in the width direction, it is possible to widen a range in which the reading reference position can be set.

In the present exemplary embodiment, the reference marker 80 is a linear marker extending along the axial direction of the opposing roll 42. Therefore, in the present exemplary embodiment, it is possible to accurately set the reading reference position compared to a case where the reference marker 80 is a linear marker extending along the rotation direction of the opposing roll 42.

In the present exemplary embodiment, the processor 100 controls the rotation position of the opposing roll 42 such that the curved surface 43B supports the document G when the document G passes between the opposing roll 42 and the reading sensor 32. For this reason, in the present exemplary embodiment, it is possible to smoothly convey the document G by supporting the document G with the curved surface 43B, compared to a configuration in which the processor 100 causes the white reference surface 46 to face the document G at the time of conveying the document G.

Furthermore, in the present exemplary embodiment, compared to a configuration in which the reference marker 80 is provided on only one end 46A side of the white reference surface 46 in the longitudinal direction, it is possible to suppress a variation in the quality of the image after the shading correction. Therefore, it is possible to suppress a variation in the quality of the image formed on the recording medium P by the image forming apparatus 10.

### Other Exemplary Embodiments

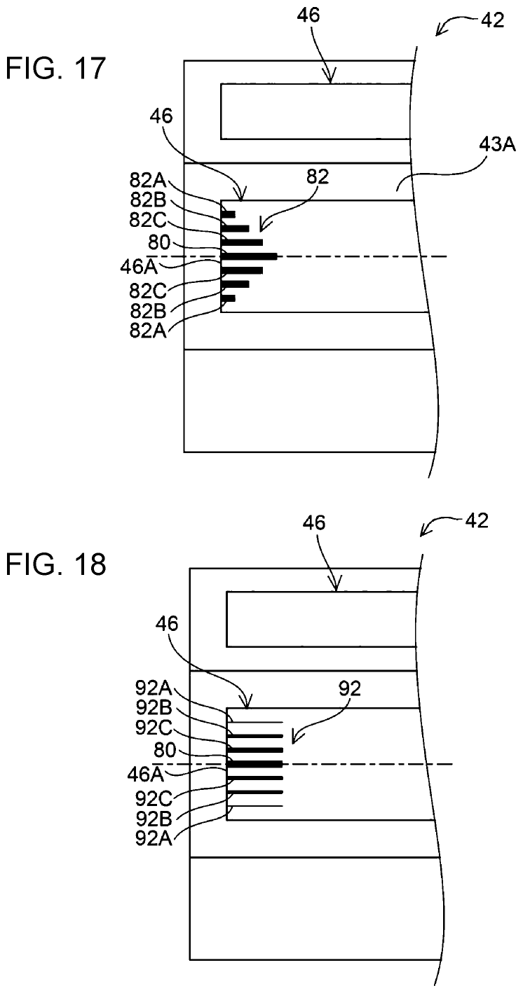

Although only the reference markers 80 are provided on the both ends 46A of the white reference surface 46 in the longitudinal direction in the above-described exemplary embodiment, the present disclosure is not limited to this configuration. For example, as illustrated in FIG. 17, an adjustment marker 82 other than the reference marker 80 may be provided on at least one end 46A of the white reference surface 46. A plurality of adjustment markers 82 are provided at positions separated from the reference marker 80 in the rotation direction of the opposing roll 42 on the white reference surface 46. Specifically, on the white reference surface 46, three adjustment markers 82 are provided on each of the both sides of the reference marker 80 in the width direction. Hereinafter, the markers are referred to as adjustment markers 82A, 82B, and 82C in the order from the marker farthest from the reference marker 80. Note that when the adjustment marker is representatively described, it is described as the adjustment marker 82.

The adjustment marker 82 described above is an example of another marker in the present disclosure. The adjustment markers 82 are linear markers and have different lengths. Specifically, the length of the adjustment marker 82 becomes shorter as the adjustment marker 82 is separated farther from the reference marker 80. That is, as illustrated in FIG. 17, the lengths of the adjustment markers 82C, 82B, and 82A become shorter in this order. Note that the present disclosure is not limited to this configuration, and the adjustment marker 82 may have a configuration in which the length increases as the adjustment marker 82 is separated farther from the reference marker 80. By making the adjustment markers 82 have different lengths in this way, the processor 100 can discriminate each of the plurality of adjustment markers 82.

Upon reading the adjustment marker 82 illustrated in FIG. 17, the processor 100 may control the rotation speed of the opposing roll 42. For example, the processor 100 may control the rotation speed of the opposing roll 42 to be decelerated when the reading sensor 32 detects the adjustment marker 82 (the adjustment marker 82A as an example) before reaching the reading reference position during the acquisition of the white reference data and control the rotation speed of the opposing roll 42 to be accelerated when the reading sensor 32 detects the adjustment marker 82 (the adjustment marker 82C as an example) after the acquisition of the white reference data. Note that the processor 100 may perform control such that the rotation speed of the opposing roll 42 is constant. In this manner, in a case where the adjustment marker 82 for adjusting the speed of the opposing roll 42 is provided on the white reference surface 46 and the adjustment marker 82 is read, the processor 100 controls the rotation speed of the opposing roll 42, and thus the speed control of the opposing roll 42 becomes easier compared to a configuration in which the rotation speed of the opposing roll 42 is controlled without depending on the marker.

Furthermore, as illustrated in FIG. 17, the processor 100 may control the rotation speed of the opposing roll 42 according to a distance between each of the adjustment markers 82 and the reading reference position. For example, the processor 100 may perform control such that, during acquisition of the white reference data, the rotation speed of the opposing roll 42 is decelerated when the reading sensor 32 detects the adjustment marker 82A before reaching the reading reference position, the rotation speed of the opposing roll 42 is further decelerated when the adjustment marker 82B is detected, and the rotation speed of the opposing roll 42 is further decelerated when the adjustment marker 82C is detected. That is, the processor 100 may decelerate the rotation speed of the opposing roll 42 in a stepwise manner each time the processor 100 detects the adjustment marker 82 before reaching the reading reference position. The processor 100 may perform control such that the rotation speed of the opposing roll 42 is accelerated in a stepwise manner each time the adjustment marker 82 is detected after acquisition of the white reference data, or may perform control such that the rotation speed of the opposing roll 42 is constant. As described above, the processor 100 controls the rotation speed of the opposing roll 42 according to the distance between each of the adjustment markers 82 and the reading reference position, and thus it is possible to control the rotation speed of the opposing roll 42 in multiple stages. Therefore, compared to a configuration in which the rotation speed of the opposing roll 42 is controlled without depending on the marker, the speed control of the opposing roll 42 becomes easier.

Further, instead of the adjustment markers 82, adjustment markers 92 illustrated in FIG. 18 may be provided on the white reference surface 46. The adjustment markers 92 are linear markers, and at least one of a line color, a line type, and a line thickness differs as the adjustment marker 92 is separated farther from the reference marker 80. In FIG. 18, the line thickness becomes thinner as the distance from the reference marker 80 increases. Note that in FIG. 18, the adjustment markers are denoted by reference signs 92A, 92B, and 92C in order from the marker farthest from the reference marker 80. Furthermore, in a case where the line type is changed as the distance from the reference marker 80 increases, for example, the markers may be configured as a one-dot chain line, a two-dot chain line, a broken line, and a dotted line in the order from the marker closest to the reference marker 80. In addition, in a case where the line color is changed as the distance from the reference marker 80 increases, for example, the color may be red, green, and yellow in order from the marker closest to the reference marker 80, or the shade of the color may be changed. By differentiating at least one of the line color, the line type, and the line thickness of each of the adjustment markers 92 in this way, the processor 100 can discriminate each of the plurality of adjustment markers 92.

The configurations of the adjustment marker 82 and the adjustment marker 92 illustrated in FIGS. 17 and 18 may be applied to the opposing roll 44. In a case of being applied to the opposing roll 44, the same operational effects as in the case of being applied to the opposing roll 42 are exhibited.

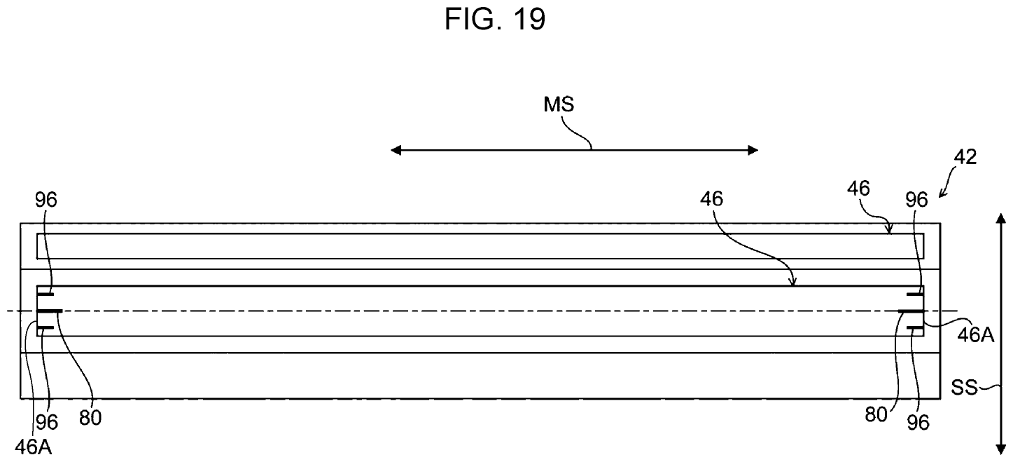

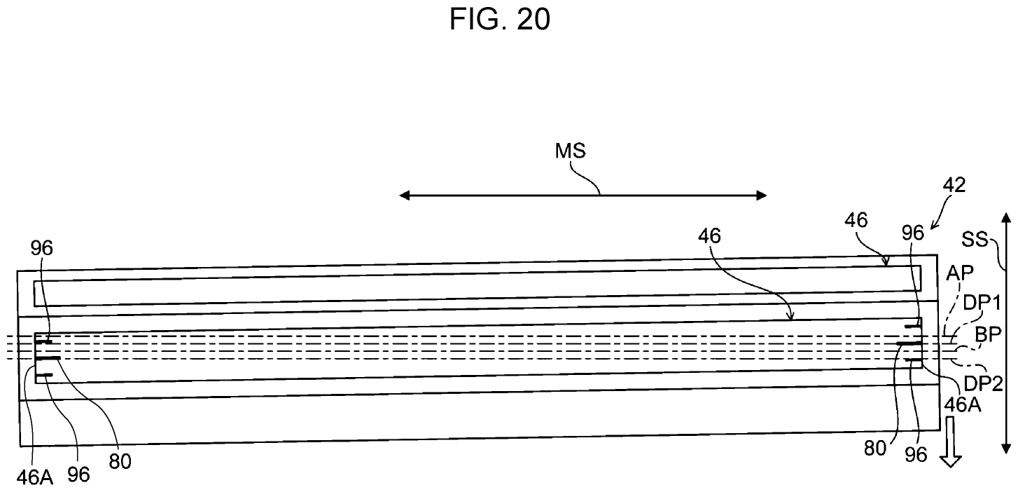

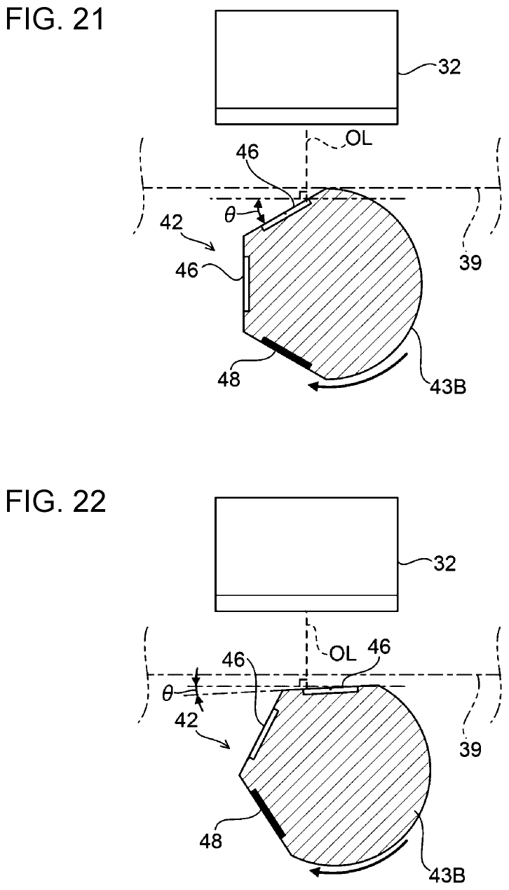

Although the white reference data is read from the white reference surface 46 at the reading reference position in the above-described exemplary embodiment, the present disclosure is not limited to this configuration. For example, as illustrated in FIG. 20, a reading correction position may be used as the reading position based on the reading reference position. Note that in FIG. 20, the reading correction position is indicated by a one-dot chain line of a reference sign AP. Furthermore, a one-dot chain line BP in FIG. 20 indicates a reading reference position. Note that in order to obtain the reading correction position, as illustrated in FIG. 19, skew detection markers 96 are provided on the both ends 46A of the white reference surface 46 in the longitudinal direction and on both sides in the width direction with the reference marker 80 as the center. Note that instead of the skew detection markers 96, both ends of the white reference surface 46 in the width direction may be regarded as the markers. Next, as illustrated in FIGS. 21 and 22, in a case where angles θ of the white reference surface 46 with respect to an orthogonal plane (indicated by a one-dot chain line in FIGS. 21 and 22) orthogonal to the optical axis OL when the two skew detection markers 96 are read (detected) are different from each other, the processor 100 determines that there is a skew. In a case where it is determined that there is a skew, the processor 100 sets a position which is separated from the reading reference position calculated from the reference marker 80 toward the skew detection marker 96 side where the angle θ between the white reference surface 46 and the orthogonal plane decreases, as the reading correction position. By reading the white reference data from the white reference surface 46 at such a reading correction position, it is possible to suppress a variation in the quality of the image after the shading correction compared to a configuration in which the reference marker 80 is provided only on the one end 46A of the white reference surface 46. Note that the difference between the angles θ obtained for the two skew detection markers 96 indicates a degree of the skew of the opposing roll 42. Furthermore, in a case where the angles θ of the white reference surface 46 with respect to the orthogonal plane when the reading sensor 32 detects the two skew detection markers 96 are the same, the processor 100 determines that there is no skew.

Note that the configuration of the skew detection markers 96 illustrated in FIGS. 19 and 20 may be applied to the opposing roll 44. In a case of being applied to the opposing roll 44, the same operational effects as in the case of being applied to the opposing roll 42 are exhibited.

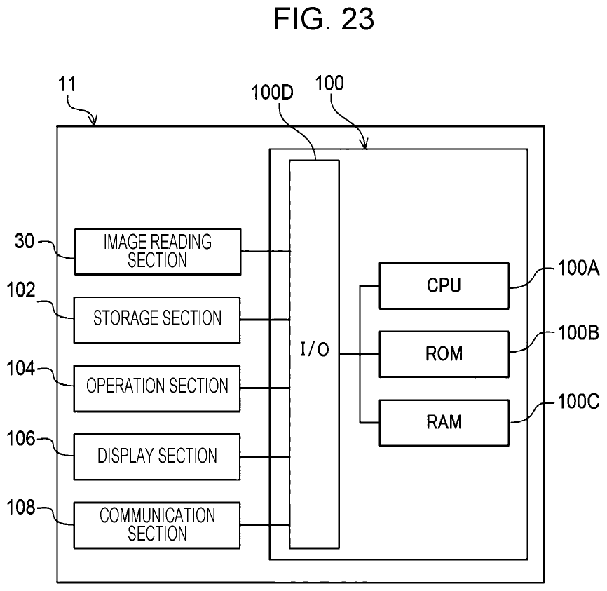

Furthermore, although the image reading section 30 is provided at the top of the image forming apparatus 10 and the image forming section 12 is provided at the bottom of the image forming apparatus 10 in the above-described exemplary embodiment, the present disclosure is not limited to this configuration. For example, the image reading apparatus 11 may be formed by the image reading section 30, the document tables 50, 60, and 70, and the processor 100. A hardware configuration of the image reading apparatus 11 is illustrated in FIG. 23. Note that the image reading apparatus 11 is an example of an image reading system in the present disclosure.

In the above-described exemplary embodiment, although the above-described image forming section 12 is used as an example of the image forming section in the present disclosure, the present disclosure is not limited thereto. As an example of the image forming section in the present disclosure, for example, a direct transfer system in which the toner image forming sections 20Y to 20K directly form toner images on the recording medium P without using the transfer body 24 may be used. Furthermore, an example of the image forming section in the present disclosure may be an image forming section that forms an image by ejecting ink onto the recording medium P. That is, the image forming section in the present disclosure is not particularly limited as long as it has a function of forming an image on the recording medium P.

Although the image reading section 30 according to the above-described exemplary embodiment includes the reading sensors 32 and 34, the present disclosure is not limited thereto. The image reading section 30 may have a configuration having only one of the reading sensors 32 and 34. In other words, the image reading section 30 only needs to be capable of reading an image on at least one surface of the document G.

The present disclosure is not limited to the above-described exemplary embodiments, and various modifications, changes, and improvements can be made without departing from the spirit of the present disclosure. For example, the modifications described above may be configured by combining a plurality of modifications as appropriate.

With respect to the above exemplary embodiments, the following appendices are further disclosed.

(((1))) An image reading system comprising:
a reading section that is provided in a conveyance path for conveying a document and that reads an image from the document conveyed through the conveyance path;
a rotating member that is disposed opposite to the reading section across the conveyance path and rotates with a main scanning direction of the reading section as an axial direction;
a flat white reference surface that is provided on an outer periphery of the rotating member and from which white reference data is read by the reading section;
reference markers that are provided on both end sides of the white reference surface in the axial direction and are read by the reading section; and
a processor that, in a case where rotation positions of the rotating member when the respective reference markers are read are different, sets a reading reference position of the white reference data between the read rotation positions of the rotating member and controls the reading section to perform reading at a position based on the reading reference position.

(((2)) The image reading system according to (((1))), wherein the processor sets, as the reading reference position, a central position between the rotation positions of the rotating member at which the respective reference markers are read.

(((3))) The image reading system according to (((1))) or (((2))), wherein the reference marker is provided at a center of the white reference surface in a width direction orthogonal to the axial direction.

(((4))) The image reading system according to any one of (((1))) to (((3))), wherein the reference marker is a linear marker extending along the axial direction of the rotating member.

(((5))) The image reading system according to any one of (((1))) to (4))), wherein
an other marker is provided on at least one end side of the white reference surface in the axial direction at a position separated from the reference marker in a rotation direction of the rotating member, and
the processor controls a rotation speed of the rotating member when reading the another

(((6))) The image reading system according to ((((5))), wherein
the other marker is one of a plurality of other markers, and the other markers are provided on at least one end side of the white reference surface in the axial direction, and
the processor controls the rotation speed of the rotating member in accordance with a distance between each of the other markers and the reading reference position.

((((7))) The image reading system according to ((((6))), wherein the other markers are linear markers and have different lengths.

((((8))) The image reading system according to ((((6))) or (((7))), wherein the other markers are linear markers, and are different in at least one of a line color, a line type, and a line thickness.

((((9))) The image reading system according to any one of ((((1))) to ((((8))), wherein
an arc-shaped support surface capable of supporting the conveyed document is provided on the outer periphery of the rotating member, and
the processor controls the rotation position of the rotating member such that the support surface supports the document when the document passes between the rotating member and the reading section.

(((10))) An image forming system comprising:
the image reading system according to any one of (((1))) to (((9))) that reads an image from a document; and
an image forming section that forms an image on a recording medium based on read image information.

What is claimed is:

1. An image reading system comprising:
a reading section that is provided in a conveyance path for conveying a document and that reads an image from the document conveyed through the conveyance path;
a rotating member that is disposed opposite to the reading section across the conveyance path and rotates with a main scanning direction of the reading section as an axial direction;
a flat white reference surface that is provided on an outer periphery of the rotating member and from which white reference data is read by the reading section;
reference markers that are provided on both end sides of the white reference surface in the axial direction and are read by the reading section; and
a processor that, in a case where rotation positions of the rotating member when the respective reference markers are read are different, sets a reading reference position of the white reference data between the read rotation positions of the rotating member and controls the reading section to perform reading at a position based on the reading reference position.

2. The image reading system according to claim 1, wherein
the processor sets, as the reading reference position, a central position between the rotation positions of the rotating member at which the respective reference markers are read.

3. The image reading system according to claim 1, wherein
the reference marker is provided at a center of the white reference surface in a width direction orthogonal to the axial direction.

4. The image reading system according to claim 1, wherein
the reference marker is a linear marker extending along the axial direction of the rotating member.

5. The image reading system according to claim 1, wherein
an other marker is provided on at least one end side of the white reference surface in the axial direction at a position separated from the reference marker in a rotation direction of the rotating member, and
the processor controls a rotation speed of the rotating member when reading the other

6. The image reading system according to claim 5, wherein
the other marker is one of a plurality of other makers, and the other markers are provided on at least one end side of the white reference surface in the axial direction, and
the processor controls the rotation speed of the rotating member in accordance with a distance between each of the other markers and the reading reference position.

7. The image reading system according to claim 6, wherein
the other markers are linear markers and have different lengths.

8. The image reading system according to claim 6, wherein
the other markers are linear markers, and are different in at least one of a line color, a line type, and a line thickness.

9. The image reading system according to claim 1, wherein
an arc-shaped support surface capable of supporting the conveyed document is provided on the outer periphery of the rotating member, and
the processor controls the rotation position of the rotating member such that the support surface supports the document when the document passes between the rotating member and the reading section.

10. An image forming system comprising:
the image reading system according to claim 1 that reads an image from a document; and
an image forming section that forms an image on a recording medium based on read image information.

11. The image forming system comprising:
the image reading system according to claim 2 that reads an image from a document; and
an image forming section that forms an image on a recording medium based on read image information.

12. The image forming system comprising:
the image reading system according to claim 3 that reads an image from a document; and
an image forming section that forms an image on a recording medium based on read image information.

13. The image forming system comprising:
the image reading system according to claim 4 that reads an image from a document; and
an image forming section that forms an image on a recording medium based on read image information.

14. The image forming system comprising:
the image reading system according to claim 5 that reads an image from a document; and
an image forming section that forms an image on a recording medium based on read image information.

15. The image forming system comprising:
the image reading system according to claim 6 that reads an image from a document; and
an image forming section that forms an image on a recording medium based on read image information.

16. The image forming system comprising:
the image reading system according to claim 7 that reads an image from a document; and
an image forming section that forms an image on a recording medium based on read image information.

17. The image forming system comprising:
the image reading system according to claim 8 that reads an image from a document; and
an image forming section that forms an image on a recording medium based on read image information.

18. The image forming system comprising:
the image reading system according to claim 9 that reads an image from a document; and
an image forming section that forms an image on a recording medium based on read image information.
